(19) United States
(12) Patent Application Publication
(10) Pub. No.: US 2013/0129269 A1
(43) Pub. Date: May 23, 2013

(54) DOUBLE-ROW SELF-ALIGNING ROLLER BEARING

(71) Applicant: Schaeffler Technologies AG & Co. KG, Herzogenaurach (DE)

(72) Inventor: Martin Grehn, Dittelbrunn (DE)

(73) Assignee: SCHAEFFLER TECHNOLOGIES AG & CO. KG, Herzogenaurach (DE)

(21) Appl. No.: 13/673,057

(22) Filed: Nov. 9, 2012

(30) Foreign Application Priority Data
Nov. 23, 2011 (DE) 10 2011086925.5

(51) Int. Cl. F16C 23/08

(52) U.S. Cl. CPC F16C 23/08
USPC 384/450

(57) ABSTRACT

A double-row self-aligning roller bearing (1) with a plurality of roller bodies (4) rolling about a bearing axis (14) on a race of an inner ring in two bearing rows (15, 16). A pressure angle (α) of a first bearing row (15) is different from a pressure angle (β) of a second bearing row (16) and/or a roller length (L1) of roller bodies (4) of a first bearing row (15) is different from a roller length (L2) of roller bodies (4) of a second bearing row (16). The inner ring (3) is divided peripherally and is formed from at least two sub-rings (3′, 3″).

### INCORPORATION BY REFERENCE

The following documents are incorporated herein by reference as if fully set forth: German Patent Application No. 102011086925.5, filed Nov. 23, 2011.

### FIELD OF THE INVENTION

The invention relates to a double-row self-aligning roller bearing with a plurality of roller bearings that roll about a bearing axis on a race of an inner ring in two bearing rows, wherein a pressure angle of a first bearing row is different from a pressure angle of a second bearing row and/or wherein a roller length of roller bodies of a first bearing row is different from a roller length of roller bodies of a second bearing row.

Such a roller bearing is known from EP 1 705 392 B1, wherein, in that document, the rollers of a left row and the rollers of a right row have different lengths and simultaneously a contact angle of a left bearing section is different from a contact angle of a right bearing section, in order to provide a roller bearing that is suitable for non-uniform axial loads. The roller bearing described in EP 1 705 392 B1, however has high disassembly and assembly costs, especially for replacing a bearing, because the necessary accessibility to the self-aligning roller bearing often requires a disassembly of surrounding machine parts or requires the destructive disassembly of the roller bearing.

### SUMMARY

The invention is based on the objective of providing a double-row self-aligning roller bearing according to the class that allows a simple and quick assembly or disassembly, especially without requiring complicated disassembly of surrounding machine parts, and wherein the double-row self aligning roller bearing is especially suitable also for the exchange of a self-aligning roller bearing already mounted on an axle.

This objective is met by a double-row roller bearing according to the invention. Here, a double-row self-aligning roller bearing according to the class is characterized in that the inner ring includes at least two sub-rings.

The invention involves the knowledge that dividing the periphery of the inner ring into two or more sub-rings creates the ability of being able to mount the inner ring on the shaft, without having to provide complete axial accessibility of the bearing point. The double-row self-aligning roller bearing according to the invention thus can be used especially as a replacement of an already mounted self-aligning roller bearing, namely in situations in which the accessibility to the bearing point is restricted by surrounding machine parts.

Embodiments of the present invention are described in detail below and in the claims.

According to one embodiment it is provided that the inner ring is made from two identical sub-rings. Each sub-ring has a periphery extending over 180 degrees. Alternatively it can be provided that the inner ring is made from two sub-rings, wherein the periphery of one sub-ring extends over more than 180 degrees. In this alternative, the two joints at which the sub-rings contact each other are arranged in one half of the inner ring reference circle and can be positioned, in particular, such that the joints are outside of the load zone.

According to one embodiment it is provided that the sub-rings of the inner ring are held together by clamping rings. Indeed, basically single-piece clamping rings are conceivable. To allow the assembly of the double-row self-aligning roller bearings according to the invention also for difficult to access bearing points, however, clamping rings formed of at least two segments can be used. It is possible to use, e.g., clamping rings formed of two half-shell-shaped segments, wherein the clamping rings can be connected to screws and threads. Furthermore, the clamping rings can be eliminated if the screws and threads are integrated into the sub-rings of the inner ring, for example, in reinforced side edges of the sub-rings of the inner ring.

If the double-row self-aligning roller bearing also has a roller bearing cage, it can be provided that this is formed of at least two segments. It is conceivable to construct, in particular, the roller bearing cage from two, e.g., identical, segments. These can be connected to each other at peripheral joints by positive-fit, non-positive-fit, and/or material-fit connections or else can be arranged loose in double-row self-aligning roller bearings. It is also possible to construct the roller bearing cage from a plurality of segments that can be connected to each other, if necessary, like a chain.

If the double-row self-aligning roller bearing also has an outer ring, it can be advantageous, depending on the installation situation, if this outer ring is formed of at least two sub-rings. The partitioning of the outer ring into sub-rings can be analogous to the partitioning of the inner ring into sub-rings: the same number of sub-rings can be selected for the outer ring and inner ring, especially the same peripheral enclosure in degrees.

As a field of use for the present invention, those applications in which double-row self-aligning roller bearings must be exchanged during the service life of the machine and those in which the corresponding bearing points are accessible only with difficulty are suitable, e.g., in main bearings of wind-power turbines or in bucket wheel excavators.

### BRIEF DESCRIPTION OF THE DRAWINGS

The invention will be described in more detail below with reference to the accompanying drawing. Shown are:

FIG. 1a is a cross-sectional view showing an axial section of a double-row self-aligning roller bearing according to the invention according to one embodiment, and

FIG. 1b is a top view of the double-row self-aligning roller bearing according to the invention according to the embodiment according to FIG. 1a.

### DETAILED DESCRIPTION OF THE PREFERRED EMBODIMENTS

Elements that are identical or have identical functions are characterized in the figures by identical reference symbols.

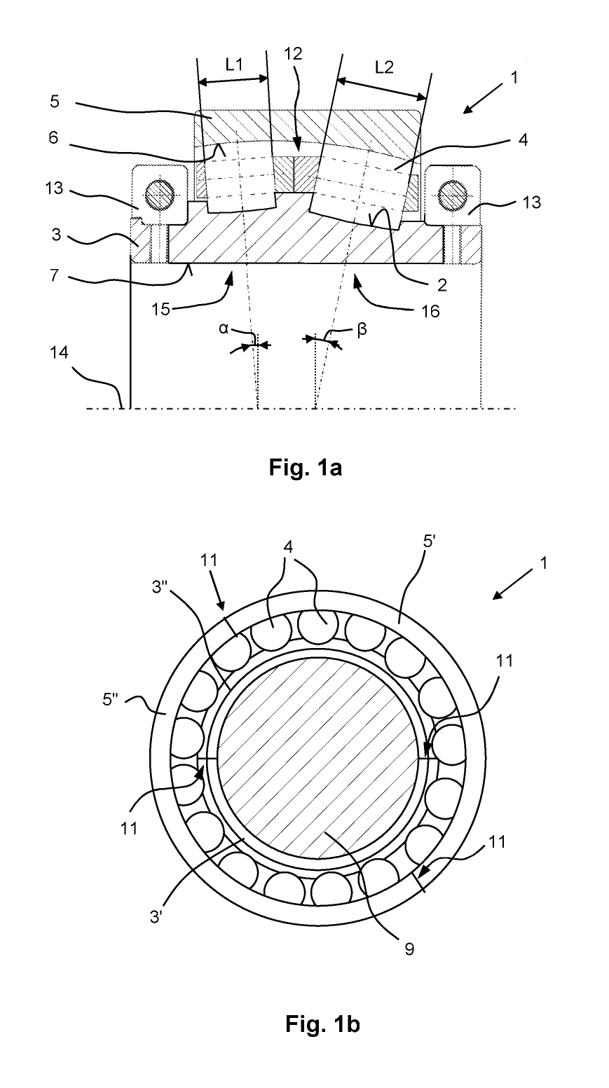

FIG. 1a shows the upper half of an axial section (sectional diagram comprising the bearing axis 14) of a double-row self-aligning roller bearing 1 according to the invention, namely a radial self-aligning roller bearing, according to one embodiment of the invention.

The double-row self-aligning roller bearing 1 comprises an inner ring 3 and also an outer ring 5 with corresponding races 2, 6. Roller bodies 4 roll about a bearing axis 14 on the races 2, 6.

The roller bodies 4 of a first bearing row 15 have the length L1 and the pressure angle α. The roller bodies 4 of a second bearing row 16 have the length L2 and the pressure angle β. To allow a higher axial load via the second bearing row 16, the length L2 is greater than the length L1 and simultaneously the pressure angle β is greater than the pressure angle α.

The inner ring 3 has an inner lateral surface 7 that contacts an outer lateral surface of a shaft 9. As can be seen in the top view in FIG. 1b, the inner ring 3 is made from two identical sub-rings 3′, 3″ that contact peripherally at two joints 11.

The sub-rings of the inner ring 3 are held together by clamping rings 13. Here, the clamping rings 13 made from two segments are arranged on an outer lateral surface of the inner ring 3 and are connected to each other, e.g., by screws.

The outer ring 5 likewise is formed of two identical sub-rings 5′, 5″.

The roller bodies 4 are guided by a roller bearing cage 12 that is formed of two segments.

### LIST OF REFERENCE NUMBERS

1 Double-row self-aligning roller bearing
2 Race (of the inner ring)
3 Inner ring
3′ Sub-ring (of the inner ring)
3″ Sub-ring (of the inner ring)
4 Roller body
5 Outer ring
5′ Sub-ring (of the outer ring)
5″ Sub-ring (of the outer ring)
6 Race (of the outer ring)
7 Inner lateral surface
9 Shaft
11 Joint
12 Roller bearing cage
13 Clamping ring
14 Bearing axis
15 Bearing row
16 Bearing row

1. A double-row self-aligning roller bearing comprising a plurality of roller bodies rolling about a bearing axis on a race of an inner ring in first and second bearing rows, at least one of a pressure angle (α) of the first bearing row is different from a pressure angle (β) of the second bearing row or a roller length of the roller bodies of the first bearing row is different from a roller length of the roller bodies of the second bearing row, and the inner ring is peripherally divided and formed from at least two sub-rings.

2. The double-row self-aligning roller bearing according to claim 1, wherein the inner ring is made from two identical sub-rings.

3. The double-row self-aligning roller bearing according to claim 1, wherein the sub-rings of the inner ring are held together by clamping rings.

4. The double-row self-aligning roller bearing according to claim 1, further comprising a roller bearing cage that is peripherally divided and formed from at least two segments.

5. The double-row self-aligning roller bearing according to claim 1, further comprising an outer ring that is peripherally divided and formed from at least two outer sub-rings.
